(19) United States
(12) Patent Application Publication
(10) Pub. No.: US 2012/0053707 A1
(43) Pub. Date: Mar. 1, 2012

(54) GAME SYSTEM AND STORAGE MEDIUM

(75) Inventor: Takao Yamamoto, Kawasaki-shi (JP)

(73) Assignee: Konami Digital Entertainment Co., Ltd., Tokyo (JP)

(21) Appl. No.: 13/218,990

(22) Filed: Aug. 26, 2011

(30) Foreign Application Priority Data
Aug. 31, 2010 (JP) 2010-194833

(51) Int. Cl. G06F 19/00

(52) U.S. Cl. 700/91

(57) ABSTRACT

In a game machine which has monitor, touch panel and sequence data storage device for storing sequence data where an operation time of touch panel in a game is stored, moves an object for indicating operation to touch panel and determination line at which the object arrives on the operation time, presents the operation time to a player and evaluates an input operation of the player based on difference between the time when the player carried out an input operation and the operation time, if the timing of the input operation of the player is located in each division among the plural divisions, a game control portion evaluates in the way that the smaller to zero the difference is, the higher the operation of the player is evaluated and presents the division to the player.

### TECHNICAL FIELD

The present invention relates to a game system which indicates predetermined operations in series to the player and the like.

### BACKGROUND ART

There is a game machine of which operating portion is operated in rhythm to music (for example, refer to the patent literature 1). In this game machine, a play of the player is evaluated by operating the operating portion in rhythm to music when an operation indicator which indicates operation time moves to a predetermined operation position. The determination ranges are configured to evaluate in the way that the farther division from the operation timing the operation of the player is placed, the lower the operation of the player is evaluated while the operation of the player coinciding with the operation timing is evaluated the highest (for example, refer to the patent literature 2).
Patent Literature 1: JP-A-2000-155543
Patent Literature 2: JP-A-2000-237455

### SUMMARY OF INVENTION

### Technical Problem

Although, in the above operation evaluation, the operation of the player is evaluated depending on where in the determination range the operation timing locates, in the operation indicator just a predetermined range centering on the operation timing is displayed. Thus the player has no choice but to operate with predicting the determination range from the position of the operation indicator and rhythm of a music piece and this sometimes causes a gap between a player's feeling and an evaluation which harms enjoyability of the game.

Then, the present invention aims to present a guideline for evaluating operation of a player as a determination range to the player to provide a game system capable of enhancing enjoyability of the game and the storage medium.

### Solution to Problem

The game system of the present invention is a game system comprising: a display device which displays a game screen; an operating device which accepts an input operation of a player; a sequence data storage device which stores sequence data in which operation time of the operation device in a game is described; an operation presentation device which makes an operation indicator for indicating an operation to the operating device and an operation reference portion at which the operation indicator arrives on the operation time move relatively on the game screen to thereby present the operation time to the player; an evaluation device which evaluates the input operation of the player based on difference between timing when predetermined input operation is carried out to the operating device and the operation time; wherein the evaluation device provides the difference with plural divisions and, when the timing of the input operation of the player is located in any one of the plural divisions, the evaluation device evaluates in the way that the smaller to zero the difference is, the higher the operation of the player is evaluated; and the game system further comprising a division presentation device which presents the divisions to the player by displaying the divisions in the operation indicator and presents the evaluation of the input operation of the player on timing when each division displayed on the operation indicator arrives in the operation reference portion in accordance with the divisions.

According to the game system of the present invention, the division for evaluating the timing when a player operates the operation indicator is presented to the operation indicator. By playing with looking at the division, It is possible for the player to predict how high the evaluation of the operation of the player is. Therefore, it is possible to enhance the enjoyability of the game by not generating the difference between the operation feeling of the player and the evaluation.

As one aspect of the game system of the present invention, further comprising a division width varying device which varies width of the division; wherein the division presentation device presents the division of which width is varied based on the division width varying device. According to this, it is possible to present the varied division to the player even if the guideline determination range of the operation evaluation of the player is varied during the game. For example, even if the tempo of the music piece on the game is varied, it is possible to control the level of the difficulty by adjusting the division. And it is possible for the player to recognize the varied division at once. Therefore, it is possible to enhance the enjoyability of the game by harming the operation feeling of the player.

As the aspect of comprising the division width varying device, on the game screen, plural operation reference portions are displayed on an indicator guide portion which guides the operation indicator unidirectionally, the operation presentation device presents the operation time with each arrival of the operation indicator to each operation reference portion, and the division width varying device varies the division of the operation indicator if operation indicator passes through the operation reference portion and moves to the next operation reference portion. According to this, it is possible to play variegated game by varying the width of the division of the operation indicator operated in series during the game. It is possible to provide the new playing feeling capable to present the determination range to the player with varying the determination with respect to each operation. As the aspect of comprising the division width varying device, the operation width varying device varies as narrowing each division of the operation indicator. Or the operation width varying device varied as widening each division of the operation indicator.

As one aspect of the game system of the present invention, the division presentation device displays the color-coded division. According to this, it is possible to present the division to the player without visible effect.

As the aspect of comprising the division width varying device, the division width varying device varies width of the division when the operation indicator moves to the operation reference portion. According to this, when the operation indicator moves to the operation reference portion, the width of the division in accordance with the operation indicator varies. It is possible for the player to operate while watching the variant of the width of the division because the width of the division of the operation indicator varies just before the operation. And it is possible for the player to play without feeling discomfort even if the width of the division of the determination range varies.

As the aspect where the division width varying device varies the width of the division while the operation indicator is moving, the division width varying device does not vary the division given the highest evaluation but the division given a lower evaluation. According to this, it is possible to control the level of the difficulty by adjusting the width of the division of the determination range in accordance with the operation indicator when the tempo varies, if the tempo of the music piece on the game varies. For example, if the tempo is fast in the middle of the music piece, although the difficulty is relatively high after varying the tempo by using the same width of the division of the determination range around the variant, it is possible to evaluate by varying widely the width of the division if the operation of the player is delayed but delay is in an acceptable range. At this time, the higher evaluation is given if the player operates with the highest division being higher level of difficulty by not varying the division given the highest evaluation but the width of the division given lower evaluation than this. And it is possible to give a player a motivation of continuing the play without feeling uncomfortable.

As the aspect where the division width varying device varies the width of the division while the operation indicator is moving, the division presentation device displays as varying width of the division based on the division width varying device and displays the division on the timing coinciding with arrival timing to the operation reference portion. According to this, division presentation device relates the timing when each division of the operation indicator arrives at the operation reference portion to the operation evaluation by varying the width of the divisions and moving the operation indicator.

The storage medium of the present invention is a storage medium storing a computer program for a game system comprising: a display device which displays a game screen; an operating device which accepts an input operation of a player; a sequence data storage device which stores sequence data in which operation time of the operation device in a game is described; wherein the computer program is constructed so as to the computer to function as: an operation presentation device which makes an operation indicator for indicating an operation to the operating device and an operation reference portion at which the operation indicator arrives on the operation time move relatively on the game screen to thereby present the operation time to the player; an evaluation device which evaluates an input operation of the player based on difference between timing when predetermined input operation is carried out to the operating device and the operation time; wherein the evaluation device provides the difference with plural divisions and, when the timing of the input operation of the player is located in any one of the plural divisions, the evaluation device evaluates in the way that the smaller to zero the difference is, the higher the operation of the player is evaluated; and the game system further comprising a division presentation device which presents the divisions to the player by displaying the divisions in the operation indicator and the evaluation of the input operation of the player on timing when each division displayed on the operation indicator arrives in the operation reference portion in accordance with the divisions.

It is possible to function as a game system of the present invention by executing the program of the present invention on the computer of the game system.

### Advantageous Effects of Invention

As mentioned above, according to the present invention, the division for evaluating the timing when a player operates the operation indicator is presented to the operation indicator. It is possible for the player to predict how high the evaluation of the operation of the player by playing with looking at the division. Therefore, it is possible to enhance the enjoyability of the game by not generating the difference between the operation feeling of the player and the evaluation.

### BRIEF DESCRIPTION OF DRAWINGS

FIG. 1 is a diagrammatic illustration of a game machine to which a game system according to one aspect of the present invention.

FIG. 2 is a functional block diagram of the game machine.

FIG. 3 is a diagram showing an outline of a game area.

FIG. 4 is a diagram showing one example of a configuration of sequence data.

FIG. 5 is a diagram showing one example of a configuration of division data.

FIG. 6 is a flowchart showing a sequence processing routine to be executed by a game control portion.

FIG. 7 is a flowchart showing an operation evaluation processing routine to be executed by a game control portion.

FIG. 8 is a diagram showing one example of relationship between operation time and a determination range of the operation.

FIG. 9 is a diagram showing an outline of a game area according to one of variations.

FIG. 10 is a diagram showing one example of a variant of each level area of an object.

FIG. 11 is a diagram showing another example of a variant of each level area of an object.

FIG. 12 is a diagram showing further another example of a variant of each level area of an object.

FIG. 13 is a diagram showing further another example of a variant of each level area of an object.

FIG. 14 is a diagram showing further another example of a variant of each level area of an object.

FIG. 15 is a diagram showing further another example of a variant of each level area of an object.

FIG. 16 is a diagram showing one example of a variant of each level area of an object according to one of variations.

FIG. 17 is a diagram showing another example of a variant of each level area of an object according to one of variations.

### DESCRIPTION OF EMBODIMENTS

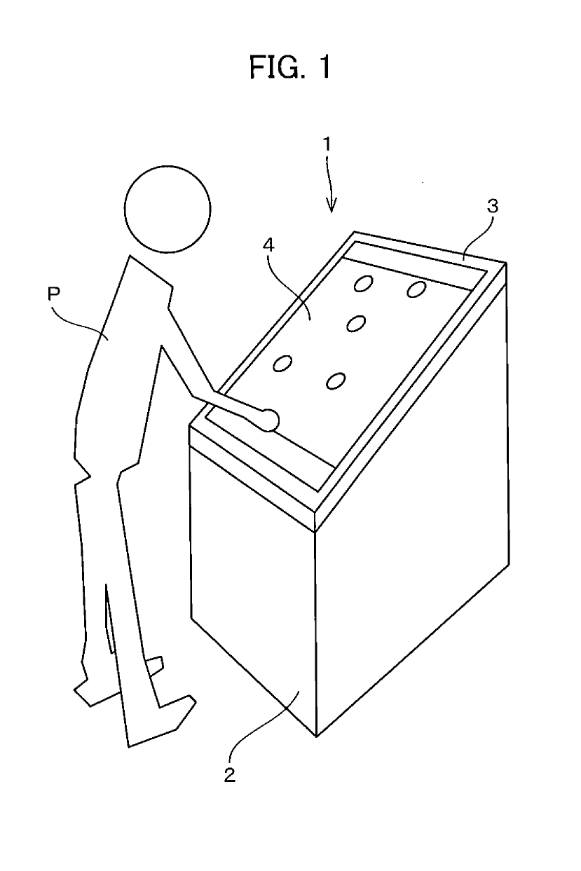

FIG. 1 is a diagrammatic illustration of a game machine to which a game system according to one aspect of the present invention is applied. The game machine 1 is a business use game machine to be installed in a commercial facility, and is configured as a music game machine which evaluates operation timings by one or more players P in accordance with the music. The game machine 1 is provided with a chassis 2 and a monitor 3 disposed on a top surface of the chassis 2 inclined toward the player P. A transparent touch panel 4 is overlapped on a surface of the monitor 3. The touch panel 4 is a conventional input device outputting signals according to touch positions where players P touch with their fingers and the like. The monitor 3 serves as a display portion, and the touch panel 4 serves as an operating portion. Additionally, the game machine 1 is provided with various types of input devices and output devices to be equipped in the business use game machine, such as buttons to make a choice or a determination, a power switch and a line indicator. However, these are not shown in FIG. 1.

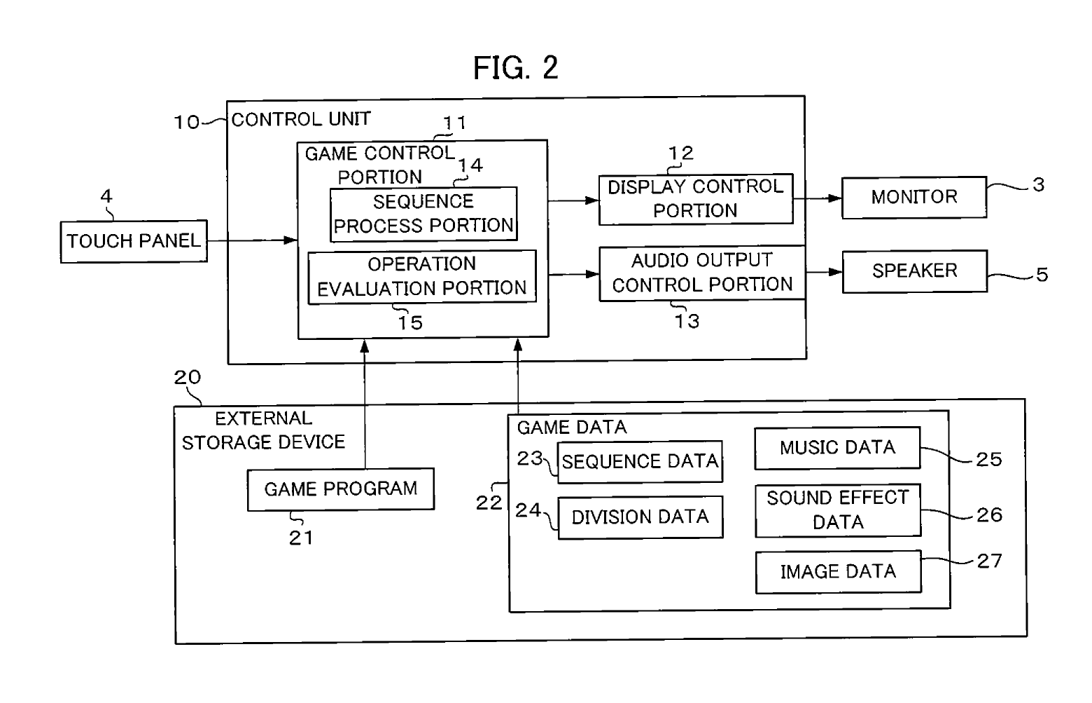

FIG. 2 is a functional block diagram of the game machine 1. The game machine 1 is provided with a control unit 10 as a computer. The control unit 10 is provided with a game control portion 11 and with a display control portion 12 and an audio output control portion 13 which operate in accordance with outputs from the game control portion 11. The game control portion 11 is configured as a unit in which a micro processor and various types of peripherals such as an internal storage device (a ROM and a RAM, for example) and the like necessary for operations of the micro processor are combined. To the game control portion 11, there is connected the touch panel 4 to accept operation by the player. The display control portion 12 displays a predetermined image on the monitor 3 by drawing an image on a frame buffer in accordance with image data provided by the game control portion 11, and issuing a picture signal corresponding to the image to the monitor 3. The audio output control portion 13 makes a speaker 5 reproduce predetermined sounds (including music sounds and the like) by generating audio playback signals in accordance with audio playback data which are provided by the game control portion 11, and outputting them to the speaker 5.

Further, to the game control portion 11, an external storage device 20 is connected. In the external storage device 20, there is used a storage medium capable of retaining memory in the absence of supply power, such as a magnetic-storage device and a nonvolatile semiconductor memory device such as an EEPROM. The storage medium of the external storage device 20 may be detachable from the game machine 1.

In the external storage device 20, a game program 21 and game data 22 are stored. The game program 21 is a computer program necessary for an execution of a predetermined music game on the game machine 1. When the game machine 1 starts up, the game control portion 11 executes various types of initializations necessary for operations of the game machine 1 by executing a operation program stored in the internal storage device, and configures environments to execute the music game based on the game program 21 by executing the game program 21 read from the external storage device 20. In the game control portion 11, a sequence process portion 14 and an operation evaluation portion 15 are generated by the execution of the game program 21. The sequence process portion 14 and the operation evaluation portion 15 are logical devices provided by a combination of computer hardware and a computer program. The sequence process portion 14 executes processing such as indications of the operation to the player P in accordance with the playback of the music (a music piece) selected by the player P and generations of the sound effects in accordance with the operation of the player P necessary for the progress of the music game. The operation evaluation portion 15 executes processing such as evaluations of the operation of the player P and indications for audio outputs in accordance with the evaluation result. In the game control portion 11, various types of logical devices, other than the logical devices previously mentioned, may be generated by the execution of the game program 21.

In the game data 22, various types of data, which are referred to at the time of the execution of the music game based on the game program 21, are included. For example, sequence data 23, division data 24, music data 25, sound effect data 26 and image data 27 are included in the game data 22. The sequence data 23 is data which defines the operation and the like to indicate to the player P. At least a piece of the sequence data 23 is prepared for a piece of the music data. Many different types of the sequence data 23 which changes a level of difficulty and the like may be prepared for a music piece. In the division data 24, determination ranges referred to at the time of operation evaluation processing is stored. In the division data 24, a number of levels to evaluate the operation, which is set at each end of an operation time described in the sequence data 23, and the range of the level are configured. The determination ranges denote ranges which are partitioned into a number of levels to evaluate the operation of the player P and include whole range. One operation range is described in a piece of the division data 24. Plural division data 24 are stored in the game data 22. In each division data 24, an identifiable code is stored respectively. The music data 25 is data necessary for a reproduced output of a music piece for a game from the speaker 5. In the game data 22, a number of the music data 25 with identifiable information with respect to each music piece are stored. In the sound effect data 26, many different types of sound effects to be issued from the speaker 5 in accordance with the operation of the player P are stored respectively corresponding to a unique code. The image data 27 includes data to be displayed in the monitor 3, such as a background image on a game screen, various types of objects O, an icon.

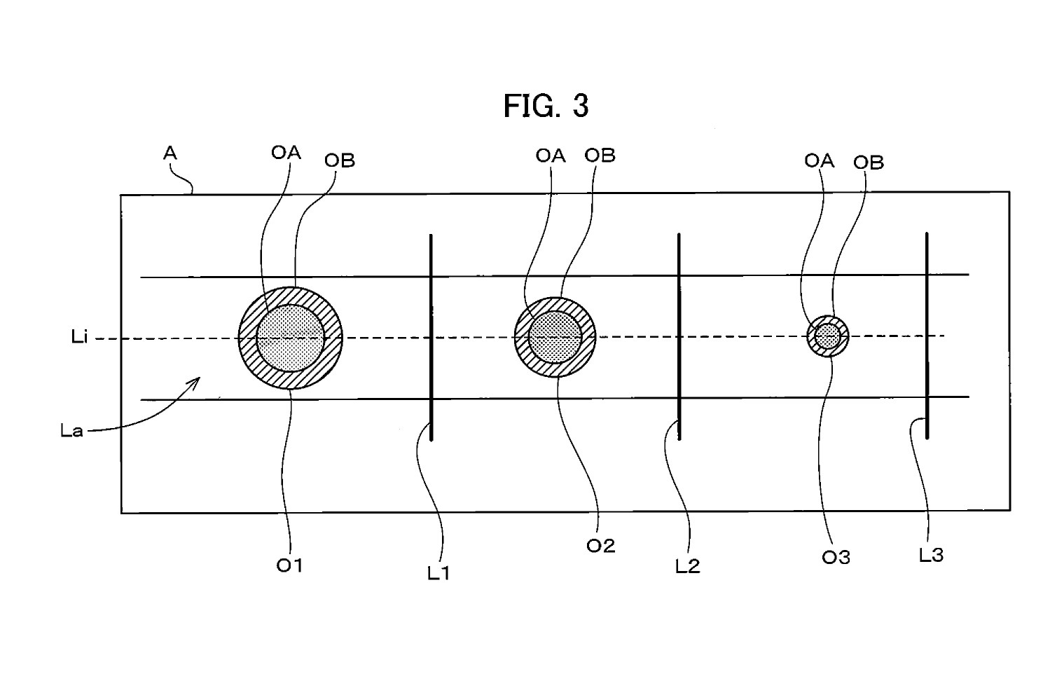

Next, an outline of the music game executed in the game machine 1 will be described. FIG. 3 shows an outline of a game area A. Outside the game area A of the game screen on the monitor 3, information necessary for the progress of the game such as score which is not shown in FIG. 3 is displayed. At the time of starting the game, in the game area A, an object O1 as an operation indicator, a lane where the object O1 moves and plural determination lines L1, L2 and L3 as an operation criterion portion are shown. (Referential marks are representative of O or L respectively, when these are not distinguished.) In FIG. 3 the objects O2 and O3 show progress with time of the object O1. FIG. 3 shows each object O1 to O3 on the same game area A for the convenience of comparison and explanation of each object O1 to O3, and does not mean each object O1 to O3 displayed on the game area A at the same time.

During the music game execution, that is, while playback of a music piece is in progress, in the game area A, the object O is shown in accordance with the sequence data 23. FIG. 3 is an example of a display of the object O1 and the determination line L1 to L3. The size of the object O and the number of the determination line L and the like can be changed arbitrarily. After the game starts, the object O1 to be operated first by the player P at appropriate time is shown at a predetermined appearance position and moves with a predetermined velocity to the determination line L1. In FIG. 3, each object O moves to the right, that is, moves to pass sequentially through each determination line L1 to L3. The object O1 moves so that a center of the object O1 arrives at the determination line L1 on the operation time described by the sequence data 23. On the object O, the determination range is shown as a division with which the operation of the player P is evaluated, specifically level A area OA including in the center of the object O and level B area OB surrounding the level A area OA. The operation of the player P is evaluated based on the level of the area where the point where an imaginary center line Li drawn to a direction of object O movement and the determination line L intersect is located on the player's operation timing of the object O1. When the point where two lines intersect on the timing of the operation is located in the level A area OA, the operation of the player P is evaluated as “Level A”. When the point is located in the level B area OB, the operation of the player P is evaluated as “Level B”. The evaluation result is shown on the game screen so that the player P make out.

After passing through the determination line L1, the object O1 becomes the object O2 that has smaller level A area OA and level B area OB than the level A area OA and the level B area OB of the object O1 respectively, and moves to the next determination line L2. The operation of the object O2 is more difficult than the operation of the object 1, because the level A area OA and the level B area OB of the object O2 are smaller than those the object O1, and the range passing through the determination line L2 are smaller. The object O2 moves to arrive at the determination line L2 on the next operation time. The operation is evaluated on the timing of the operation of the player P. After passing through the determination line L2, the object O2 becomes the object O3 has smaller level A area OA and the level B area OB than the object O2, and moves to the next determination line L3. The operation of the object O3 is more difficult than the operation of the object O2 because the determination range of the object O3 is smaller than the determination range of the object O2. The touch operation to the touch panel 4 by the player P is evaluated on the timing of arriving at the determination line L3, that is, the operation time. The subsequent objects O move from left to right in accordance with the sequence data 23.

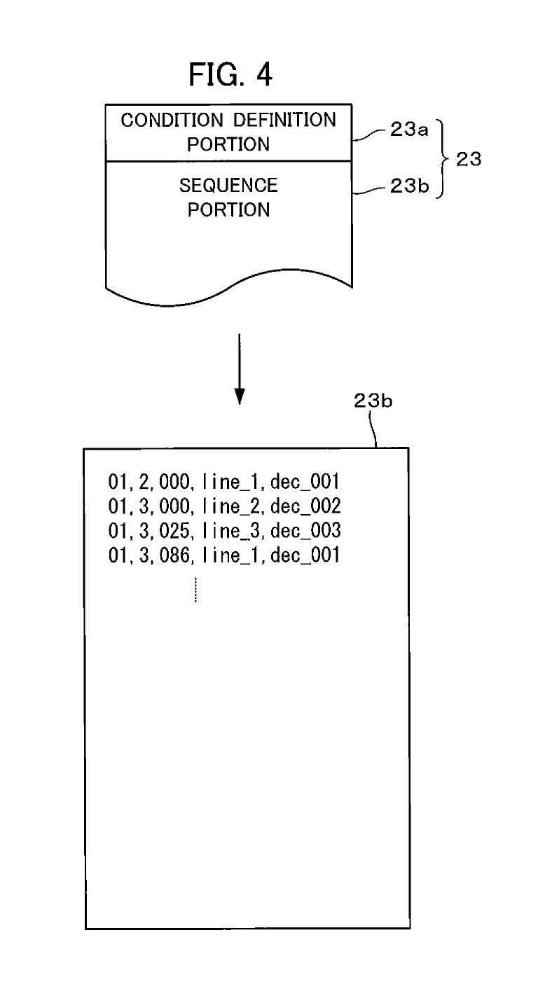

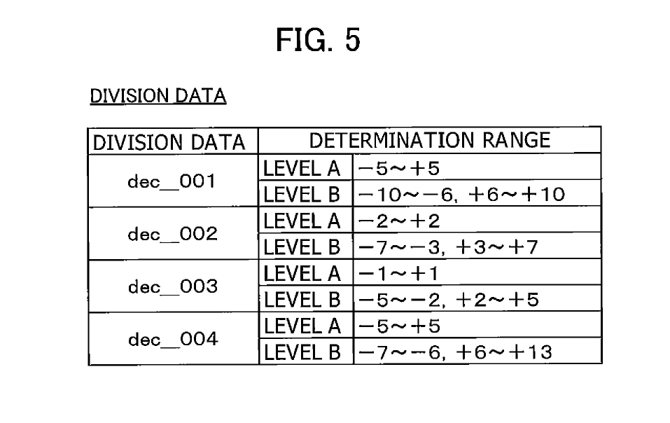

Next, further details about the sequence data 23 will be described in reference to FIG. 5. As shown in FIG. 4, the sequence data 23 is included in a condition definition portion 23a and a sequence portion 23b. In the condition definition portion 23a, information to specify a execution condition of the game which differs from one music piece to another such as the tempo of the music (BPM (Beats per Minute), for example) and information to specify the sound effects when the player P operates the touch panel 4 is described.

In contrast, in the sequence portion 23b, the determination lines L to be operated by touching the object O that appeared in the game area A on the appropriate time on the music piece and the operation time are described. To explain the object O1 to O3 described above as examples, the operation time corresponding one-to-one with the object O is described, and the determination line L corresponding to the operation time when the object arrives at is described. The division data 24 to specify the determination range described above is described to correspond to the operation time and the determination line L. As a part of the sequence portion 23b is shown in FIG. 4 for example, the sequence portion 23b is configured as set of plural records where the operation time, the determination line L and the division data 24 corresponding to the respective data are described. In the operation time of the each record, bar number on the music piece, the number of beat and the time in the beat which are delimited by a comma are described respectively. The time in the beat is elapsed time since the top of a beat and expressed as number from the top of the beat to divide time of a beat into n equal parts. For example, if n=100, the second bar first beat and the time when quarter passed from the top of the beat are specified as appearance timing, it is described as “02, 1, 025”.

In the case of FIG. 4, the object O1 coinciding with the determination line L1 on the top of the first bar second beat (000) is touch operated (in the sequence portion 23b, it is specified as “line_{—}1”). The next object O2 moves to coincide with the determination line L2 on the top of the first bar third beat (000). The object O that arrives at the corresponding determination line L on the operation time described in the sequence data 23 is touch operated. The determination range of each object O moving in the lane La is specified by the division data 24. In FIG. 5, an example of the division data 24 is shown. In the division data 24, the determination ranges of the level A area OA and the level B area OB are specified respectively. For example, the determination range “−5 to +5” specifying the level A area OA indicates arrival timing, that is, the basis of the evaluation of the timing of the operation has a margin of plus or minus 5 frames. Suppose, 1 frame is 1/60 seconds as an example. The evaluation of the player operation is level A, level B or failure determination depending on which range the difference between the operation time and the timing of the actual operation of the player P locates. In the sequence portion 23b, for example, a piece of the division data 24 is specified as “dec_{—}001”. In FIG. 4, the head of the sequence data 23 is only provided with the condition definition portion 23a, a condition setting portion (not shown) which has information such as information specified the tempo on the music piece, as with the condition definition portion 23a, and information specified the sound effect which is generated when the player P operates the touch panel 4 may be included in appropriate location in the middle of the sequence portion 23b. It is possible to execute the processing such as change of the tempo on the music piece and change of assigned sound effect by including such condition setting information in the sequence portion 23b.

Next, processing of the game control portion 11 when the music game is executed in the game machine 1 will be described. The game control portion 11 executes initial settings necessary for the execution of the music game by reading the game program 21 and then stands by for the indications by the player P to start the game. The operation to identify data for use in the game such as selections of the music piece played on the game or the level of difficulty is included in the indication to start the game. Acceptance of these indications may follow the same procedure as the conventional music game and the like.

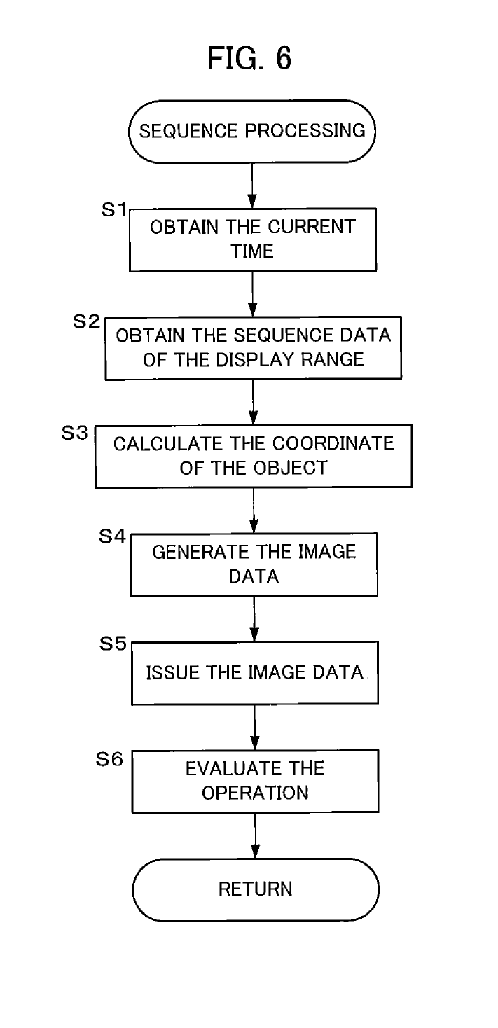

When the game's beginning is indicated, the game control portion 11 starts to play the music from the speaker 5 by reading the music data corresponding to the music selected by the player P and outputting the music data at the audio output control portion 13. The game control portion 11 displays the game area A on the monitor 3 by outputting the image data necessary for drawings of the game area A to the display control portion 12 with reference to the image data by reading the sequence data 23 corresponding to the selection of the player P in synchronization with the playback of the music piece. During the execution of the music game, the game control portion 11 repeatedly executes a sequence processing routine shown in FIG. 6 at predetermined intervals as the processing necessary for the display of the game area A and the like. The sequence processing portion 14 executes the routine shown in FIG. 6.

When the sequence processing routine shown in FIG. 6 is executed, the sequence processing portion 14 of the game control portion 11 obtains the current time on the music piece in the first step S1. For example, timer is started with an internal clock in the game control portion 11 on the basis of the point of playback starting time of the music piece and the current time is obtained from the value of the internal clock. In the next step S2, the sequence processing portion 14 obtains data of the operation time from the sequence data 23 existing in the duration corresponding to a display range of the game area A. As an example of the display range, a time range corresponding to two bars of the music piece from the current time to the future is configured.

In the next step S3, the sequence processing portion 14 calculates coordinates of the object O to display on the lane L. For example, this calculation is performed as follows. The sequence processing portion 14 decides the position where the object O appears in the lane La based on the specification of the determination line L corresponding to the operation time included in the predetermined time above. And the sequence processing portion 14 discerns the position of each object in the temporal axis direction (moving direction of the object O) from the determination line L in accordance with the temporal difference between the operation time and the current time. For example, if the determination line L2 corresponding to the operation time is specified, the object O is displayed in such a way as to coincide with the determination line L2 at the operation time. If the determination line L corresponding to the previous operation time is the determination line L1, each object O is displayed in series.

In the next step S4, the sequence processing portion 14 generates the image data necessary for drawing the game area A based on the coordinate of the object O calculated by the step S3. Specifically, the image data is generated as the object O is arranged at the calculated coordinate. The image of the object O is drawn in the lane La in the size of the level A area OA and the level B area OB is determined based on the division data 24. The image of the object O may be obtained from the image data 27 of the game data 22 or be generated based on the division data 24. For example, if the division data 24 on the determination line L1 is specified as “dec_{—}001”, the each size of the level area OA and OB is defined based on that. The image of the object O is drawn in such a way as to change the position based on the coordinate of the object O calculated by the step S3 without changing the image of the object O1 from the generation of the object O1 to the determination line L1.

In the next step S5, the sequence processing portion 14 issues the image data 27. This makes the monitor 3 show the game area A. Then, in the step S6, the sequence processing portion 14 makes the operation evaluation portion 15 execute the evaluation processing of the operation timings of the player P at the obtained operation time in the step S2. The operation timing evaluation will be discussed below. The sequence processing portion 14 quits the sequence processing routine after finishing the processing of the step S6. Shown in the lane La, the object O which the determination range is specified of moves to coincide with the determination line L corresponding to the operation time by executing the above processing repeatedly.

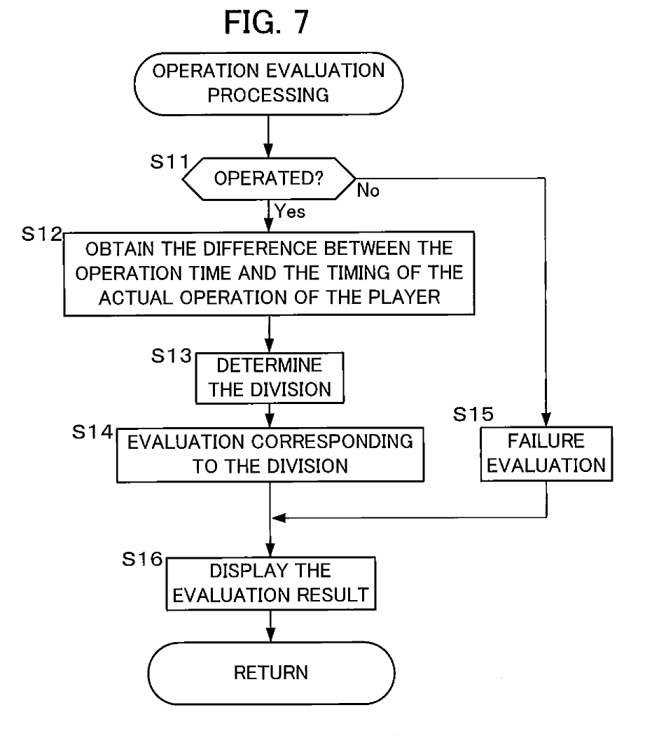

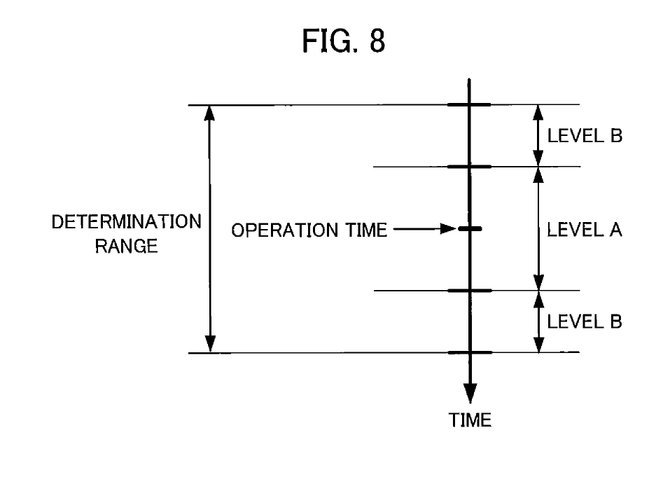

Next, it will be described an operation evaluation processing routine executed by the operation evaluation portion 15 with reference to FIG. 7. In the step S11, if the operation evaluation processing routine in FIG. 7 is executed, the operation evaluation portion 15 evaluates whether or not the operation of the player P at the operation timing is the operation in the determination range of the target object O. A predetermined time range centered at the operation time described in the sequence data 23 is configured as the determination range like an example in FIG. 8, and further the determination range is configured as multiple levels A and B. If the operation of the player P at the operation timing P is the operation in the determination range, in the next step S12, the operation evaluation portion 15 obtains the difference between the operation time corresponding to the operated object O and the timing of the actual operation of the player P. In subsequent step S13, the operation evaluation portion 15 determines a division in which the operation of the player P is included based on the difference. This determination of the division refers to the corresponding division data 24 by the sequence data 23. It is obtained which level this difference is located at by comparing the difference with the determination range of the division data 24. In principle, though the smaller the difference is, the higher level the evaluation of the operation is, it is not necessarily the case that the evaluation is high level depending on the progress of the game. It is possible to adjust the evaluation levels by the level set at the division data 24. Further, even a division determined by the same operation timing differs depending on the division data 24 to be referred; it is possible to adjust the level of difficulty by appropriate choice of the division data 24.

In the next step S14, the operation evaluation portion 15 evaluates the operation of the player P corresponding to the division determined in the step S13. Meanwhile, if the operation evaluation portion 15 evaluates as it is not the operation in the determination range, that is, the player P operates out of the determination range or does not operate, the operation evaluation portion 15 evaluates the operation as a failure evaluation in the step S15. After the evaluation of the operation of the player P in the step S14 or the step S15, the operation evaluation portion 15 indicates the display control portion 12 to show evaluation results on the game screen. And the operation evaluation portion 15 quits the operation evaluation processing.

According to the operation evaluation processing, the operation is evaluated by the division data 24 corresponding to the object O operated by the player P and by the difference between the operation time and the timing of the actual operation of the player P based on the sequence data 23. On the game screen, the object O is shown based on the determination range specified by the division data 24 and passes through the determination line L at the same timing as the evaluation of the operation timing. Therefore, it is possible to enhance the enjoyability of the game by presenting the determination range to the player P.

In the above embodiment, the external storage device 20 of the game machine 1 serves as the sequence data storage device. The sequence processing portion 14 serves as the operation presentation device, the division presentation device and the division width varying device by executing the step S1 to S5 of the sequence processing routine. Further, the operation evaluation portion 15 serves as the evaluation device by executing the operation evaluation processing routine.

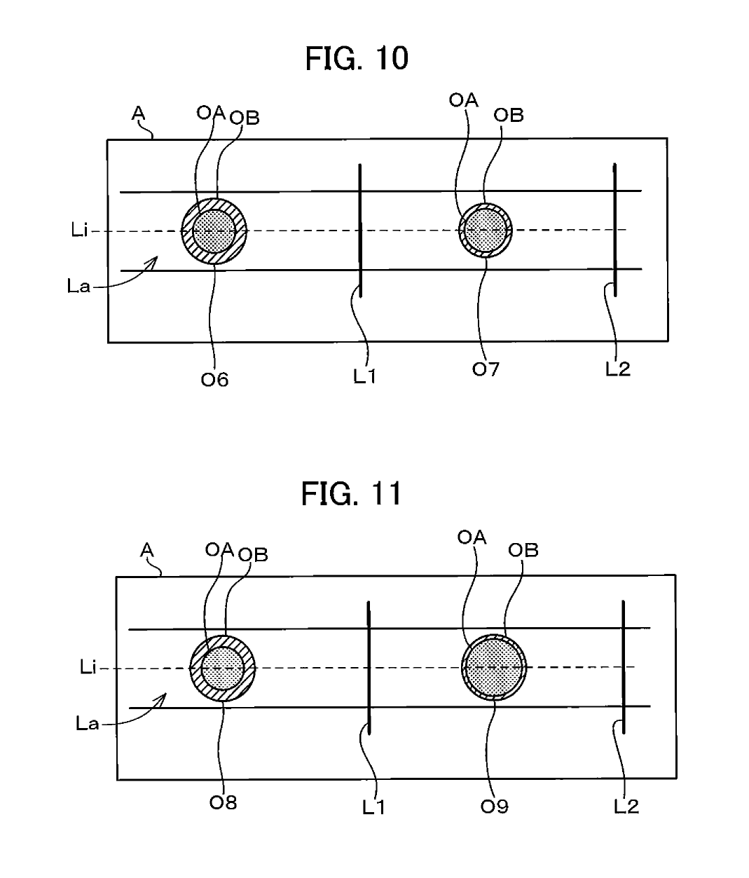

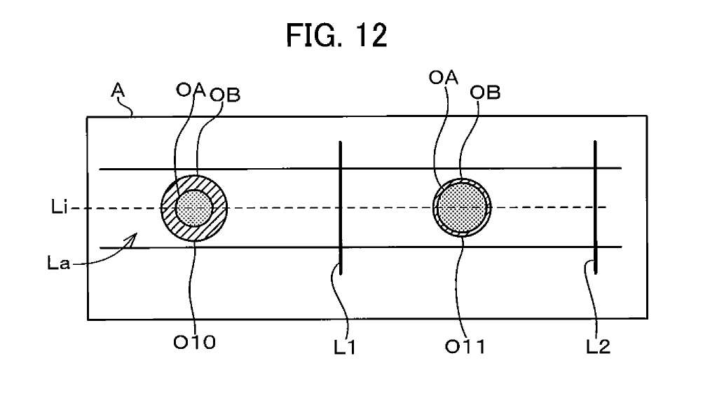

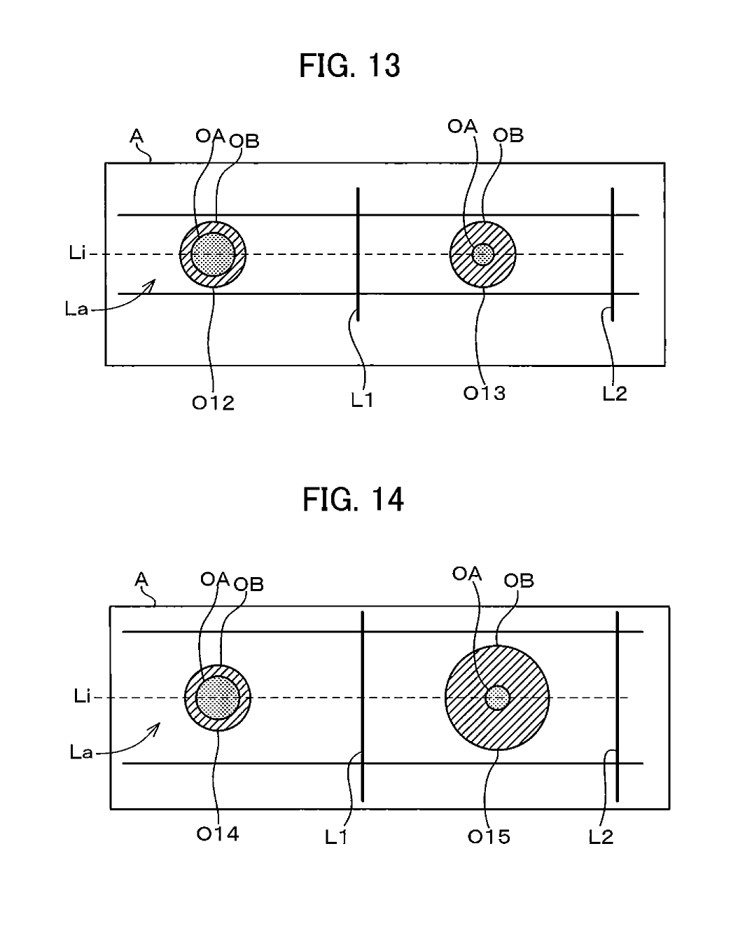

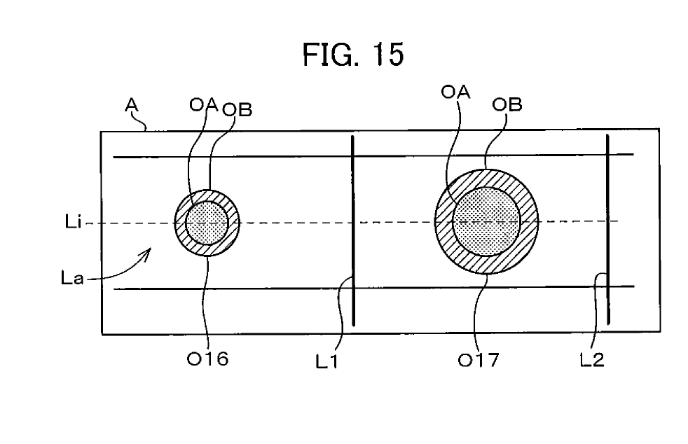

The present invention is not limited to the aforementioned embodiment and can be realized in various kinds of embodiments. For example, in this embodiment, it is described that the shape of the object varies as both the level A area OA and the level B area OB are becoming smaller with time shown in FIG. 3, it is not limited. For example, the level A areas of the two objects O6 and O7 operated in series shown in FIG. 10 may be the same in size and the level B area of the object O7 may be smaller than the level B area of the object O6. It is enough to prepare for the division data 24 of the determination range corresponding to the object O. It is possible to control the level of difficulty by adjusting the level A area OA and the level B area OB of the object O depending on the progress of the game. In addition, the level A area of the object O9 operated with the object O8 in series shown in FIG. 11 may be bigger than the level A area of the object O8 and the level B areas of the two object O8 and O9 may have the same upper and lower limit. It may be easy to obtain the evaluation as “level A” because of enlarge the level A area OA. The level A area of the object O11 operated with the object O10 in series shown in FIG. 12 may be bigger than the level A area of the object O10 and the level B area of the object O11 may be smaller than the level B area of the object O10. Further, the level A area of the object O13 operated with the object O12 in series shown in FIG. 13 may be smaller than the level A area of the object O12 and the level B area of the two object O12 and O13 may have the same upper and lower limit. The level A area of the object O15 operated with the object O14 in series shown in FIG. 14 may be smaller than the level A area of the object O14 and the level B area of the object O15 may be bigger than the level B area of the object O14. It is possible to respond to the wide-ranging player from beginners to experts by making it easy to obtain the evaluation as “level B” and hard to obtain the higher evaluation. The level A area and the level B area of the object O17 operated with the object O16 in series shown in FIG. 15 may be bigger than the each area of the object O16. The level of difficulty may be lowered. In regard to the control of the level of difficulty, the game may become easy or difficult according to the level of proficiency.

Although, in the above embodiment, the object O is configured with the level A area OA and the level B area OB, it is not limited to this. More divisions may be set the level. It is possible to vary accordingly as the division by colors or lines, and displaying color gradient and the like in respect to the display shown the level by the object O. Although it is described the three determination line L1 to L3 as plural determination line L, it is not limited to this. The determination line L may be increased or decreased accordingly. It is possible to enhance the enjoyability of game by presenting the determination range to the player P with adjusting the size of the each level area OA and OB of the objects O operated in series.

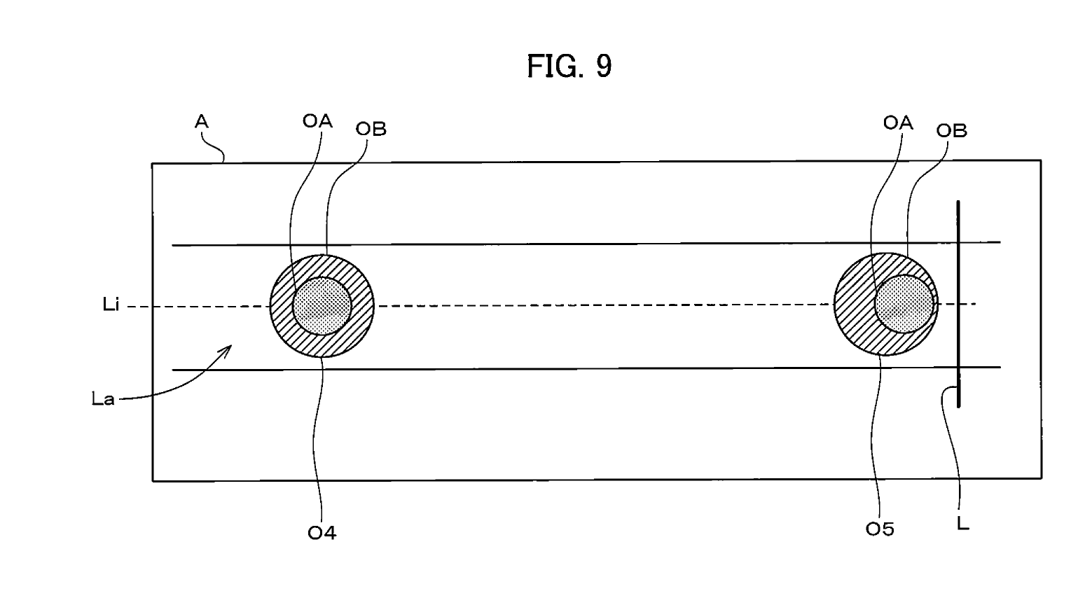

Although, in the above embodiment, the object O1 shown in FIG. 3 moves to change the each area OA and OB to the object O2 after passing the determination line L1, it is not limited to this. The level A area OA and the level B area OB may change with moving. The outline of the game area A of the one of variations is shown in FIG. 9. In FIG. 9, the object O4 and the object O5 do not show the progress with time of the different object but the same object O. In FIG. 9, the object O4 moves from the left to the right and arrives at the determination line L on the operation time indicated by the sequence data 23. The object O4 appearing from the predetermined appearance position moves to the determination line L with changing each level area OA and OB as shown by the object O5. In the one of variations, after the object O appeared on the lane La the level A area and the level B area change by the arrival of the object O to the determination line L. In each concentric area OA and OB of the object O4, the center of the level B area OB moves behind with getting close to the determination line L and the level A area OA moves to slant relatively to the determination line L. The operation time of the object O does not change when the object O varies from the object O4 to the object O5. The upper and lower limit of the level B area OB is variable as the criterial operation time is invariable.

The division data 24 corresponding to the sequence data 23 specifies the determination range at the timing when the object O passes through the determination line L and each area OA and OB appearing at the lane La may be specified accordingly. For example, at the appearance of the object, the division data 24 of the object O having the concentric determination range at all times may be specified in the condition definition portion 23a, or the division data 24 defining each area OA and OB at the appearance of each object O in the sequence portion 23b and the division data 24 defining each area OA and OB at the operation time may be specified. In each case, the image data of which each area OA and OB of the object varies may be obtained based on the time from the appearance of the object to the operation time and the distance. As an example, if at the appearance the concentric determination range (for example, the level A area OA is specified by “−5 to +5” and level B area OB is specified by “−10 to −6 and +6 to +10”) is set and the object O at the operation time is specified by “dec_{—}004” of the division data 24 in FIG. 5, the level B area OB varies and the level A area OA does not vary. The display of the level A area OA is controlled to move toward traveling direction of the object O with moving of the object O. To specify the determination range of the division data 24 is not limited to this. For example, the variant of the upper and lower limit of the level B area OB may be specified corresponding to the way of the object O.

In the present variation, it is possible to process the sequence processing routine similar to above embodiment. The sequence processing portion 14 obtains the necessary division data 24 in the step S2 of FIG. 6 and in the step S3 calculates the coordinate of the object O based on the obtained division data 24. In the step S4, sequence processing portion 14 generates the image data based on the calculate result of the step S3. The sequence processing portion 14 may obtain the variable shape of the object O from the image data 27 or may calculate the variable shape necessary for drawing the object O in the step S3 and generate the image data based on this calculated result in the step S4. It is possible to use well known art of interpolation processing and the like for the drawing of the object O. In the following step S5, the sequence processing portion 14 issues the image data 27 to the display control portion 12. The game area A is shown in the monitor 3 herewith.

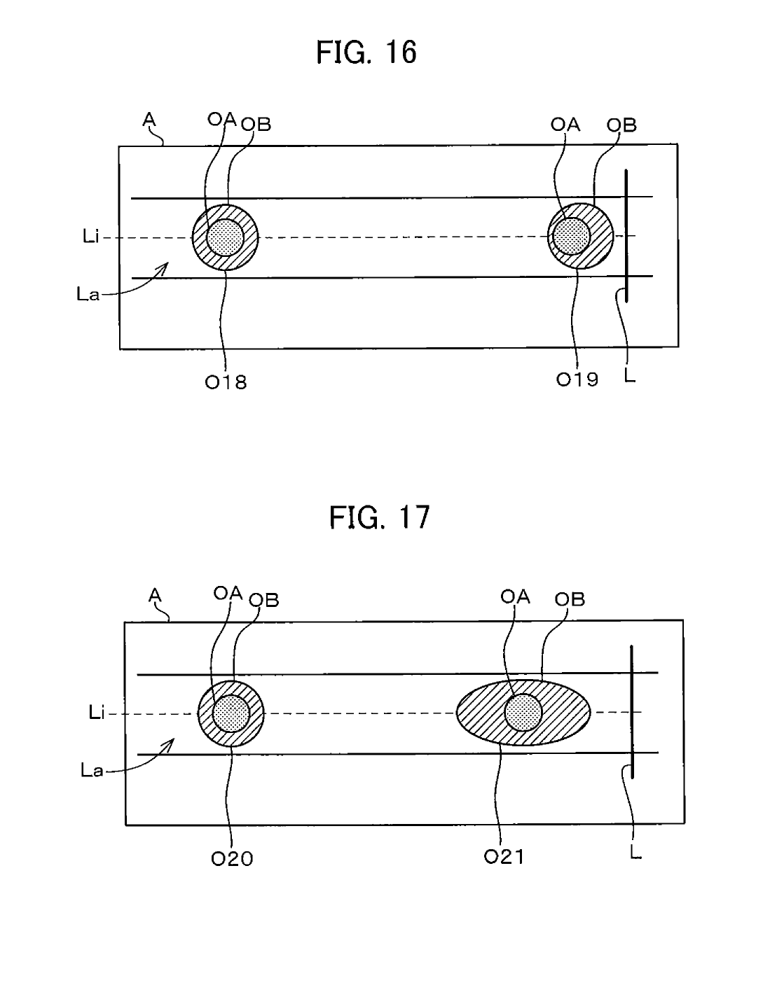

It is not limited to the case of FIG. 9. As shown in FIG. 16, the center of the level B area OB may move forward as changing from the object O18 to the object O19. As shown in FIG. 17, the level B area OB may widen in the longitudinal direction as changing from the object O20 to the object O21 or the level B area OB may narrow. Thus, by changing not the level A area OA but the level B area OB, it is possible to evaluate the operation of the player P without making the player feel discomfort, whether the tempo of the music piece changes or not. For example, if the tempo of the music piece changes slower, the operation of the player P tends to be delayed because the player P operates after looking at the object O but it is possible to evaluate the delayed operation by shifting the level B area OB backward. It is possible to shift the level B area OB forward or backward in order to make the game easier or harder based on the result of analyzing player P's tendency such as operating too early or too late. It is possible to widen or narrow the determination range of level A area OA. It is possible to change the area OA and OB by setting the division data 24. As for an operation evaluation processing, a processing similar to that shown in FIG. 7 may be applied.

Though, in this variation, the object O consists of level A area OA and level B area OB, it is not limited to this. It is possible to provide with more divisions. It is possible to display the determination range in various ways such as colors, lines and gradations. Though, in this variation, only one lane La is mentioned, it is just an example. It is possible that the game has a game area A with plural lanes La. Also, this variation can be applied to the game with plural determination lines L like above mentioned embodiment.

Though, in the above mentioned embodiments, the division of the determination range is displayed in the object O provided with level A area OA and level B area OB, it is not limited to this. It is possible to display the division of the determination range in the specially designed area on the game screen that is out of the object O. Any way for display may be applied if the player P can recognize the division of the determination range. Though, in the above mentioned embodiment, the determination range of the object O is concentric, it is possible to display a rectangular determination range. If the object O is rectangular, the determination range of the object O needs to be divided in order to coincide on the arrival timing in the determination line L.

Though, in this embodiment, the gaming machine 1 is explained as the business use game machine, it is not limited to this. For example, a consumer use game machine, a mobile game machine, a mobile phone with gaming function and a game system using network can be applied. Operating portion is not limited to the touch panel 4. For example, a controller with operation buttons can be applied. In this case, if the game has plural determination lines L, it is possible to evaluate the operation timing of the key by assigning each determination line L to each key. Input device that can accept an audio input operation or an operation by a gaze can be applied.

1. A game system comprising:
a display device which displays a game screen;
an operating device which accepts an input operation of a player;
a sequence data storage device which stores sequence data in which operation time of the operation device in a game is described;
an operation presentation device which makes an operation indicator for indicating an operation to the operating device and an operation reference portion at which the operation indicator arrives on the operation time move relatively on the game screen to thereby present the operation time to the player;
an evaluation device which evaluates the input operation of the player based on difference between timing when predetermined input operation is carried out to the operating device and the operation time; wherein
the evaluation device provides the difference with plural divisions and, when the timing of the input operation of the player is located in any one of the plural divisions, the evaluation device evaluates in the way that the smaller to zero the difference is, the higher the operation of the player is evaluated; and the game system further comprising
a division presentation device which presents the divisions to the player by displaying the divisions in the operation indicator and presents the evaluation of the input operation of the player on timing when each division displayed on the operation indicator arrives in the operation reference portion in accordance with the divisions.

2. The game system of claim 1, further comprising
a division width varying device which varies width of the division; wherein
the division presentation device presents the division of which width is varied based on the division width varying device.

3. The game system of claim 2, wherein
on the game screen, plural operation reference portions are displayed on an indicator guide portion which guides the operation indicator unidirectionally,
the operation presentation device presents the operation time with each arrival of the operation indicator to each operation reference portion, and
the division width varying device varies the division of the operation indicator if operation indicator passes through the operation reference portion and moves to the next operation reference portion.

4. The game system of claim 2, wherein
the operation width varying device varies as narrowing each division of the operation indicator.

5. The game system of claim 2, wherein
the operation width varying device varied as widening each division of the operation indicator.

6. The game system of claim 1, wherein
the division presentation device displays the color-coded division.

7. The game system of any one of claims 2 to 6, wherein
the division width varying device varies width of the division when the operation indicator moves to the operation reference portion.

8. The game system of claim 7, wherein
the division width varying device does not vary the division given the highest evaluation but the division given a lower evaluation.

9. The game system of claim 7, wherein
the division presentation device displays as varying width of the division based on the division width varying device and displays the division on the timing coinciding with arrival timing to the operation reference portion.

10. A storage medium storing a computer program for a game system comprising:
a display device which displays a game screen;
an operating device which accepts an input operation of a player;
a sequence data storage device which stores sequence data in which operation time of the operation device in a game is described; wherein
the computer program is constructed so as to the computer to function as:
an operation presentation device which makes an operation indicator for indicating an operation to the operating device and an operation reference portion at which the operation indicator arrives on the operation time move relatively on the game screen to thereby present the operation time to the player;
an evaluation device which evaluates an input operation of the player based on difference between timing when predetermined input operation is carried out to the operating device and the operation time; wherein
the evaluation device provides the difference with plural divisions and, when the timing of the input operation of the player is located in any one of the plural divisions, the evaluation device evaluates in the way that the smaller to zero the difference is, the higher the operation of the player is evaluated; and the game system further comprising
a division presentation device which presents the divisions to the player by displaying the divisions in the operation indicator and the evaluation of the input operation of the player on timing when each division displayed on the operation indicator arrives in the operation reference portion in accordance with the divisions.
